(19) United States
(12) Patent Application Publication
(10) Pub. No.: US 2026/0084321 A1
(43) Pub. Date: Mar. 26, 2026

(54) END EFFECTOR FOR WELDING COMPONENTS ONTO STRUCTURES

(71) Applicant: Deere & Company, Moline, IL (US)

(72) Inventors: Michael EASTERDAY, Calamus, IA (US); Jacob MARTZ, Davenport, IA (US); Jarret SCHMOLL, Cambridge, IL (US)

(21) Appl. No.: 18/891,910

(22) Filed: Sep. 20, 2024

(51) Int. Cl. B25J 15/00; B25J 11/00

(52) U.S. Cl. CPC B25J 15/0019; B25J 11/005

(57) ABSTRACT

An end effector for a robotic welder includes a plurality of component-receiving reservoirs that receive components that are to be welded to a work surface of base structure. A stripper plate rotates to move a component from one of the component-receiving reservoirs to a deployed position. A central actuator is controlled to clamp the component into frictional engagement with the work surface. A welding head performs a tack weld and the central actuator is retracted, out of engagement with the component. The welding head then welds the tack welded component to the work surface.

### FIELD OF THE DESCRIPTION

The present description relates to an end effector for a robotic tool. More specifically, the present description relates to an end effector for automatically welding components to a structure.

### BACKGROUND

There are a wide variety of types of end effectors for robotic tools. Some end effectors include welding heads that are used to weld structures.

Many different types of machines are built from structures that are welded together. Some welded structures use small hardware pieces or components (referred to herein as trinkets) that are used as locators or restrainers that locate and restrain hydraulic lines, electrical wire harnesses, mounting brackets, etc. It is not uncommon, for instance, for a vehicle frame to have hundreds of different trinkets to be welded onto the vehicle frame.

The discussion above is merely provided for general background information and is not intended to be used as an aid in determining the scope of the claimed subject matter.

### SUMMARY

An end effector on a robotic welder includes a plurality of component reservoirs that are configured to receive components that are to be welded to a work surface of a base structure. The end effector includes a rotary stripper plate configured to move the components from the component reservoir to a deployed position. The end effector includes a linear actuator that is actuated to hold the deployed component in frictional engagement with the work surface. A welding head is configured to tack weld the component to the work surface and complete other welding to weld the component to the work surface. The linear actuator is then actuated to move out of engagement with the component.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 shows one example of a base structure with components (trinkets) welded to different work surfaces of the base structure.

FIG. 2 is a pictorial perspective view of one example of an end effector.

FIG. 3 is a pictorial perspective view of one example of an end effector.

FIG. 4 is a pictorial perspective view of one example of an end effector.

FIG. 5 is a pictorial perspective view of one example of an end effector.

FIG. 6 is a sectional view of the end effector shown in FIG. 2 taken along section lines 6-6.

FIG. 7 is a partial cross-section, partial cut away view of one example of an end effector taken along line 7-7.

FIG. 8 is a perspective view of a stripper plate.

FIG. 9 is a top view of one example of a set of stripper plates.

FIG. 10 is a partial cross-sectional view of a portion of the end effector.

FIG. 11 is a flow diagram showing one example of the operation of an end effect.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

As discussed above, in many industries, (such as industries that manufacture construction machines, forestry machines, agricultural machines, and other industries that manufacture welded structures etc.), it is not uncommon for relatively small hardware components to be welded to a work surface of a base structure. The small hardware components are used for alignment purposes, and/or for securing pneumatic and electronic harnesses, among other things. Such components may be referred to herein as “trinkets”, and there may be a large number of trinkets that need to be welded to work surfaces on different pieces of a machine.

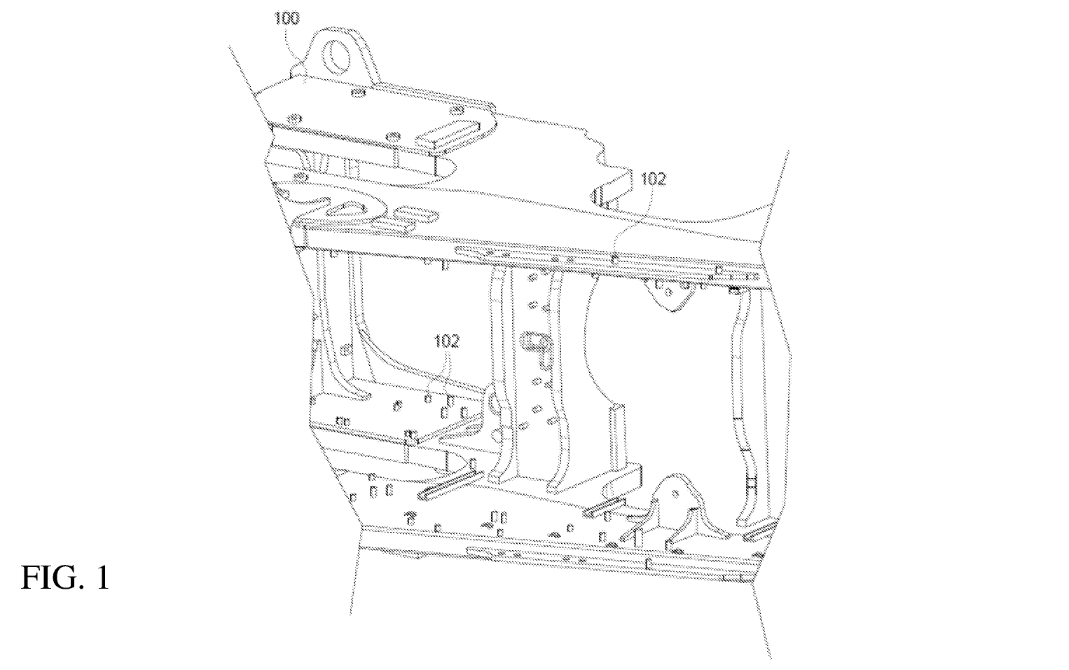

FIG. 1, for instance, shows one example of a base structure 100 that has a plurality of different work surfaces. FIG. 1 also shows that a large number of small cylindrical components 102 (e.g., trinkets 102) are welded to substantially every work surface on base structure 100. Only some of the trinkets 102 are labeled in FIG. 1, and others are shown but not labeled.

In current manufacturing systems, trinkets are often manually applied and welded onto the work surfaces of a base structure 100. This can take a great deal of time, and may be error prone. Thus, the present description describes a system that includes an end effector on a robot. The end effector automatically positions and welds trinkets to a work surface of a base structure.

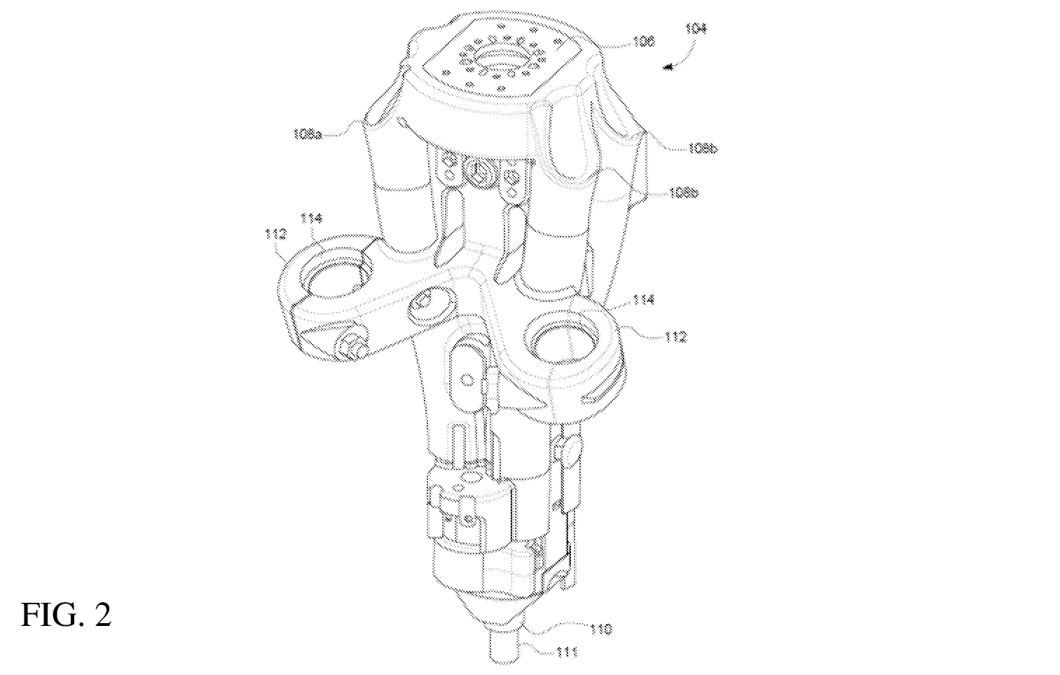

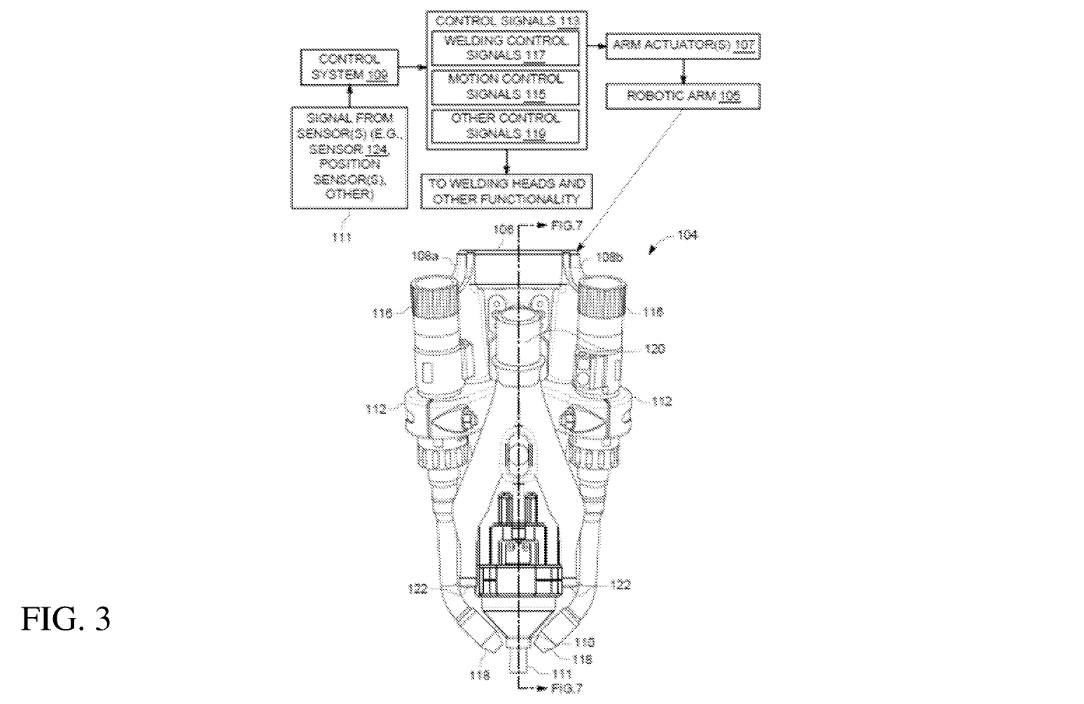

FIG. 2 is a pictorial illustration of one example of an end effector 104 that has an attachment surface 106 that can be attached to a robot or a robotic arm. End effector 104 has a plurality of tubular trinket-receiving reservoirs (also referred to as component-receiving reservoirs or reservoirs) 108 that have an interior surface that defines a reservoir chamber (or chamber). In operation, the trinkets are loaded into reservoirs 108 where the trinkets are guided downwardly to a distal tip 110 of end effector 104. The trinkets are held in place by an actuator clamp (illustrated in other figures), that clamps or otherwise holds the trinket in frictional engagement with a work surface and one or more welding heads (also illustrated in FIGS. 3, 4, and 5) weld the trinket into place on the work surface.

In the example shown in FIG. 2, the welding heads (shown in FIGS. 3, 4, and 5) can be removably attached to end effector 104 using brackets 112 that define apertures 114. As discussed below with respect to FIGS. 3, 4 and 5, the welding heads extend through apertures 114 down toward the distal tip 110 of end effector 104 where welds are performed. FIG. 2 also shows that a trinket 111 is in a deployed position, extending out from within the distal tip 110 of end effector 104.

FIG. 3 is also a pictorial illustration of one example of end effector 104. Some items shown in FIG. 3 are similar to those shown in FIG. 2, and those items are similarly numbered. FIG. 3 shows that welding heads 116 are held in place within brackets 112. The welding heads 116 are configured with welding tips 118. Also, in FIG. 3, a vacuum tube 120 is mounted to end effector 104 with openings 122 positioned to remove fumes from the area proximate welding tips 118, during operation.

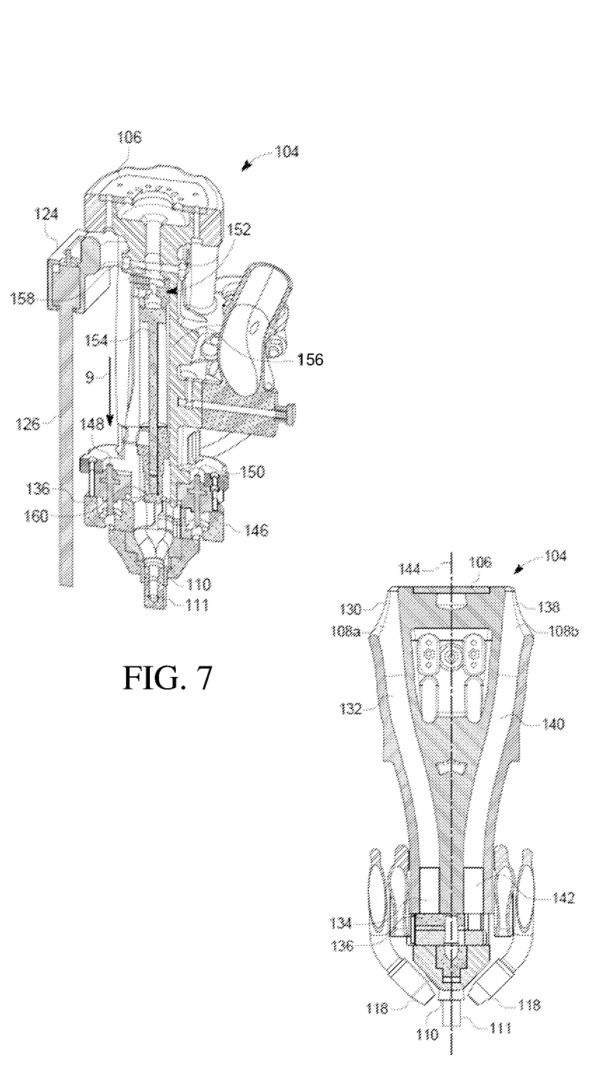

FIG. 3 also shows that end effector 104 can be mounted to, and moved by, a robotic arm 105. Robotic arm 105 may be an articulated arm, a multi-axis (e.g., a six-axis) arm, a linear robot (or Cartesian arm), a cylindrical arm, a polar or spherical arm, a selective compliance assembly robot arm (SCARA), a delta robot arm, or another arm. Depending on the type of robotic arm 105, a set of actuators 107 are configured to control movement of robotic arm 105. A control system 109 is configured to run a control algorithm which receives sensor signals 111 from sensors on end effector 104, and/or any of a variety of other inputs, and generate a set of control signals 113. The control signals can include motion control signals 115 that control arm actuators 107 to generate desired movement of end effector 104. Control signals 113 can also include welding control signals 117 that control welding heads 116. Control signals 113 can also include a variety of other control signals 119 to control other functionality of robotic arm 105 and/or end effector 104, such as rotation of stripper plates 136 and 146 and linear actuator 152 described below with respect to FIGS. 7-11.

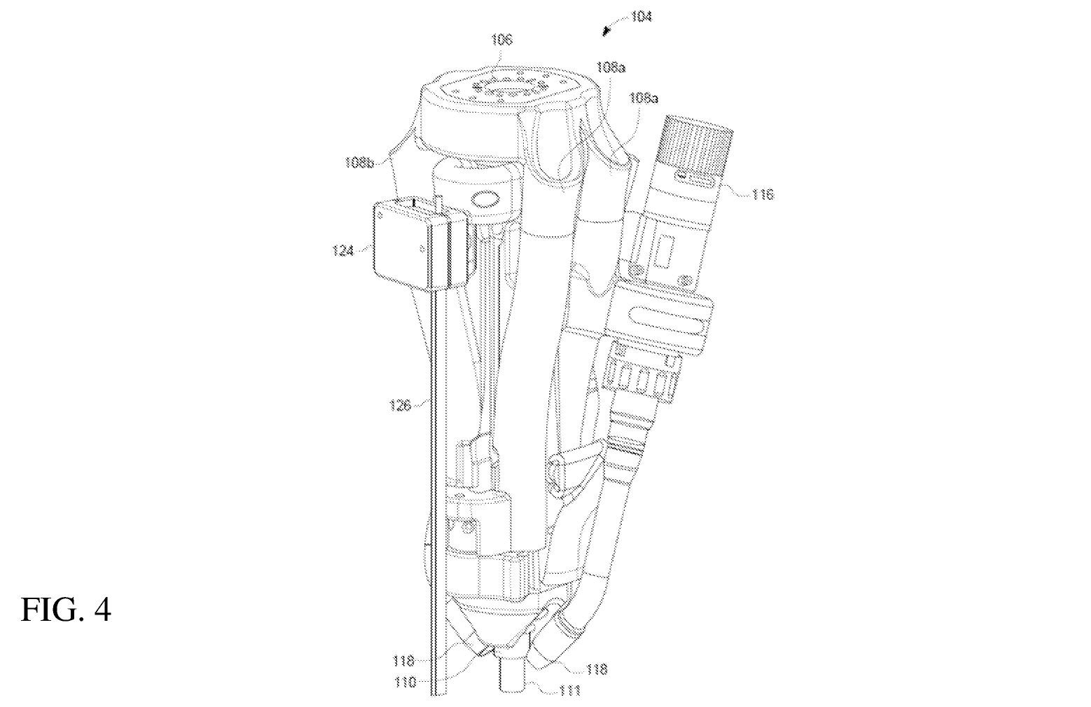

FIG. 4 is also a pictorial illustration of one example of end effector 104. Some items are similar to those shown in previous figures, and those items are similarly numbered. FIG. 4 shows that end effector 104 is also configured with a sensor 124. Sensor 124 is configured to sense the distance between sensor 124 and a work surface to which trinket 111 is to be welded. Sensor 124 can include a depending sensing finger or sensing arm 126 which mechanically deflects upon contact with the work surface. In another example, sensor 124 can include a laser sensor or another sensor that senses the position of end effector 104 relative to a work surface to which trinket 111 is to be welded.

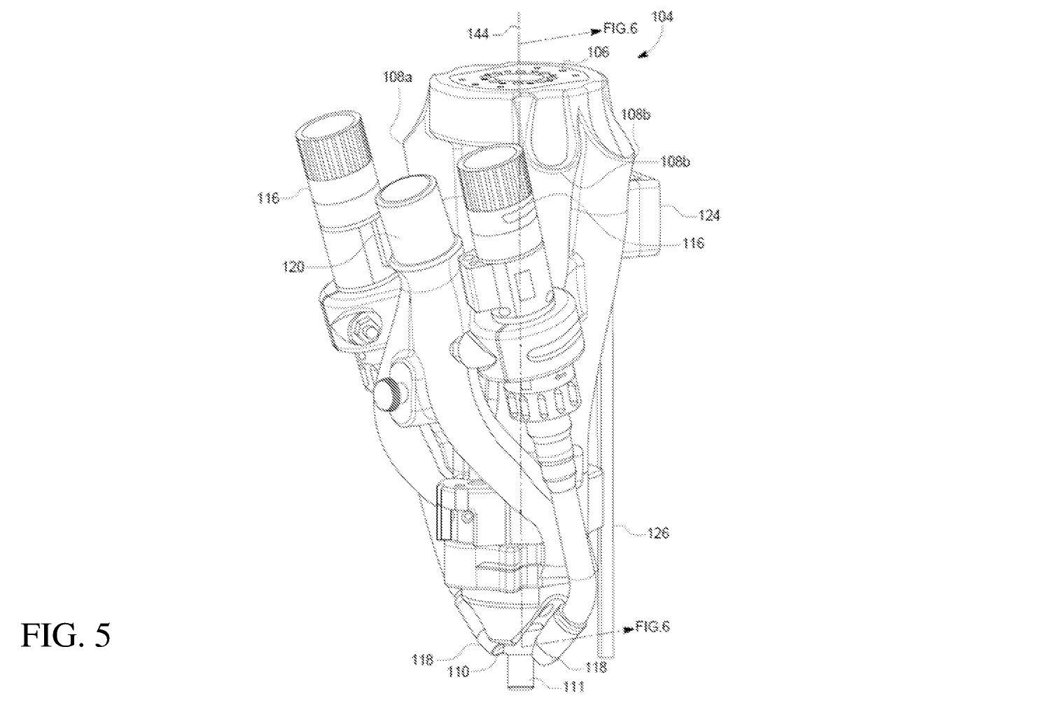

FIG. 5 is also a pictorial illustration of one example of end effector 104. Some items are similar to those shown in previous figures and those items are similarly numbered. FIG. 5 shows that, in the illustrated example, end effector 104 includes a plurality of reservoirs 108 on opposite sides of end effector 104. For example, FIGS. 4 and 5 illustrate that there are a plurality of trinket-receiving reservoirs 108a disposed closely proximate one another about an axis 144 defined by end effector 104 and there are a plurality of trinket-receiving reservoirs 108-b disposed closely proximate one another about axis 144 of end effector 104.

FIG. 6 is a cross-sectional view of end effector 104 taken along section lines 6-6 in FIG. 5. Some items in FIG. 6 are similar to those shown in previous figures, and those items are similarly numbered. FIG. 6 shows that each of the trinket-receiving reservoirs 108a and 108b (collectively referred to as reservoirs 108) each define a reservoir chamber that guides movement of trinkets 111 therealong. In the example shown in FIG. 6, reservoir 108-a receives trinkets through a trinket receiving aperture (or inlet end) 130 and guides the trinkets (using the force of gravity or another force) along a chamber 132 to a distal end 134 (or outlet end) of the chamber 132. The trinkets are moved from a loaded position at the distal end 134 of chamber 132 to a deployed position (as illustrated by trinket 111) by an actuatable stripper plate 136. Stripper plate 136 (shown in greater detail below) rotates to move a trinket from the loaded position in the distal end 134 of chamber 132 to an axially central position of end effector 104 where the trinkets fall into the deployed position shown by trinket 111 so the trinket can be welded to the work surface of the base structure.

Similarly, FIG. 6 shows that trinket-receiving reservoir 108b includes a trinket receiving aperture (or inlet end) 138 which receives trinkets and defines a reservoir chamber 140 which guides the trinkets down to a distal end (or outlet end) 142 of chamber 140. The stripper plate 136 (or a different stripper plate) can be configured to also move a trinket from the distal end 142 of chamber 140 into the deployed position illustrated by trinket 111. As discussed in more detail below with respect to FIG. 7, Stripper plate 136 illustratively rotates to move the trinket from the distal ends 134 and 142 of chambers 132 and 140, respectively, into the deployed position.

FIG. 7 is a partial cutaway view of the end effector 104 illustrated in previous figures taken along section line 7-7 shown in FIG.3. Some of the items in FIG. 7 are similar to those shown in previous figures, and those items are similarly numbered. FIG. 7 shows a cross-sectional view of a plurality of stripper plates 136 and 146. Stripper plate 136 has a corresponding actuator that is actuatable to rotate stripper plate 136 about an axis 148 while stripper plate 146 has a corresponding actuator (which may be the same actuator used to rotate stripper plate 146 or a different actuator) that is actuatable to rotate stripper plate 146 about an axis 150. FIG. 7 also shows that end effector 104 is configured with a centrally located actuator clamp which may be a linear actuator 152. Linear actuator 152 includes a rod 154 that is reciprocally movable within a cylinder 156. Thus, linear actuator 152 can be a pneumatic actuator, a hydraulic actuator, or another actuator. The actuator 152 is actuated to extend rod 154 within cylinder 156 in a direction toward the distal tip 110 of end effector 104 and to retract rod 154 within cylinder 156 in a direction away from the distal tip 110 of end effector 104. Therefore, a distal tip 160 of rod 154 is reciprocally movable in the direction toward distal tip 110 of end effector 104 and away from distal tip 110 of end effector 104 by actuating linear actuator 152.

In operation, when a trinket 111 is moved to the deployed position by one of the stripper plates 136 or 146, then actuator 158 is actuated to extend rod 154 so that the distal tip 160 of rod 154 frictionally engages trinket 111 and holds trinket 111 in frictional engagement with the work surface to which trinket 111 is to be welded. The welding tips 118 are then controlled to tack weld trinket 111 to the work surface, at which point linear actuator 152 can be actuated to retract rod 154 within cylinder 156 so that the distal tip 160 of rod 154 is out of engagement with the trinket 111. At that point, the welding tips 118 can again be controlled to complete the welding operation. In one example, end effector 104 is moved by robotic arm 105 to rotate relative to axis 144 (shown in FIG. 6). Therefore, after tack welding trinket 111 to the work surface, the end effector 104 can be rotated about central axis 144 while welding tips 118 are welding the trinket 111 to the work surface.

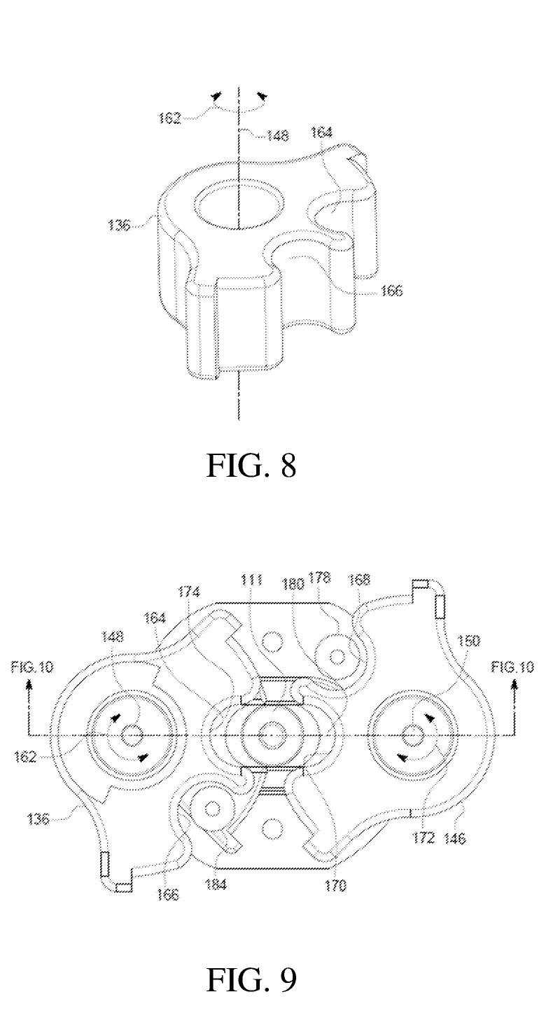

FIG. 8 shows one example of a stripper plate 136. Stripper plate 136 can be actuated by a rotary actuator to rotate in the direction indicated by arrow 162 about axis 148. Stripper plate 136 has a plurality of trinket receiving cavities 164 and 166 defined therein.

FIG. 9 is a top view of the stripper plates 136 and 146 looking downward generally in the direction of arrow 9 shown in FIG. 7. FIG. 9 shows that stripper plate 146 also has a trinket-facing surface that defines a pair of trinket-receiving concavities (or component-receiving concavity, or concavity) 168 and 170. Further, FIG. 9 shows that stripper plate 146 can be actuated by a rotary actuator to rotate about axis 150 in the direction indicated by arrow 172.

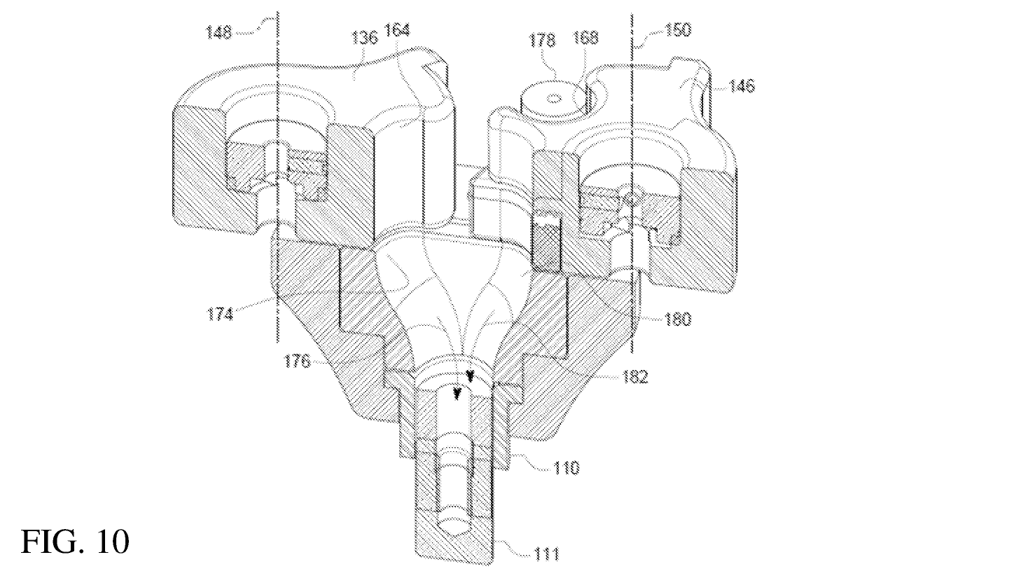

FIG. 10 is a sectional view of a portion of end effector 104, taken along section line 10-10 shown in FIG.9, showing stripper plates 136 and 146 mounted relative to the distal tip 110 of end effector 104. FIGS. 9 and 10 will now be described in conjunction with one another.

In FIGS. 9 and 10, a first trinket 111 has been moved by stripper plate 136 from a loaded position at the distal end of reservoir 108 to a deployment chamber 174 where trinket 111 is guided by gravity in the direction indicated by arrow 176 through the distal tip 110 of end effector 104 into the deployed position. In one example, chamber 174 has an inner profile shaped to route trinket 111 downwards, vertically to the deployed position. The inner diameter of distal tip 110 is configured to avoid wobble or side-to-side movement of trinket 111. FIGS. 9 and 10 also show that another trinket 178 is in a loaded position in the trinket-receiving concavity 168 in stripper plate 146. When stripper plate 146 is actuated to rotate so that trinket-receiving concavity 168 is aligned with a deployment chamber 180, then trinket 178 will be guided downwardly by deployment chamber 180 in the direction indicated by arrow 182 into the deployed position. FIG. 9 also shows that trinket-receiving concavity 166 has now grabbed a trinket 184 from another one of the reservoirs 108. Therefore, when stripper plate 136 is subsequently actuated to rotate so that trinket-receiving concavity 166 is aligned with deployment chamber 174, then trinket 184 , is guided through deployment chamber 174 in the direction indicated by arrow 176, into the deployed position.

It can thus be seen that stripper plates 136 and 146 can be reciprocated back and forth in the direction indicated by arrows 162 and 172, respectively, so that the trinket-receiving concavities 164, 166, 168, and 170 alternately align with the different reservoirs 108-a, and 108-b to receive trinkets that are in loaded positions at the distal ends of reservoirs 108 (e.g., trinket 178 is in the loaded position in FIG. 9, as is trinket 184) and with the deployment chambers 174 and 180. This movement causes the trinket receiving concavities 164166168 and 170 to alternately grab a trinket from a reservoir 108 and move the trinket to the deployment chamber 174, 180 where the trinket falls into the deployed position for welding.

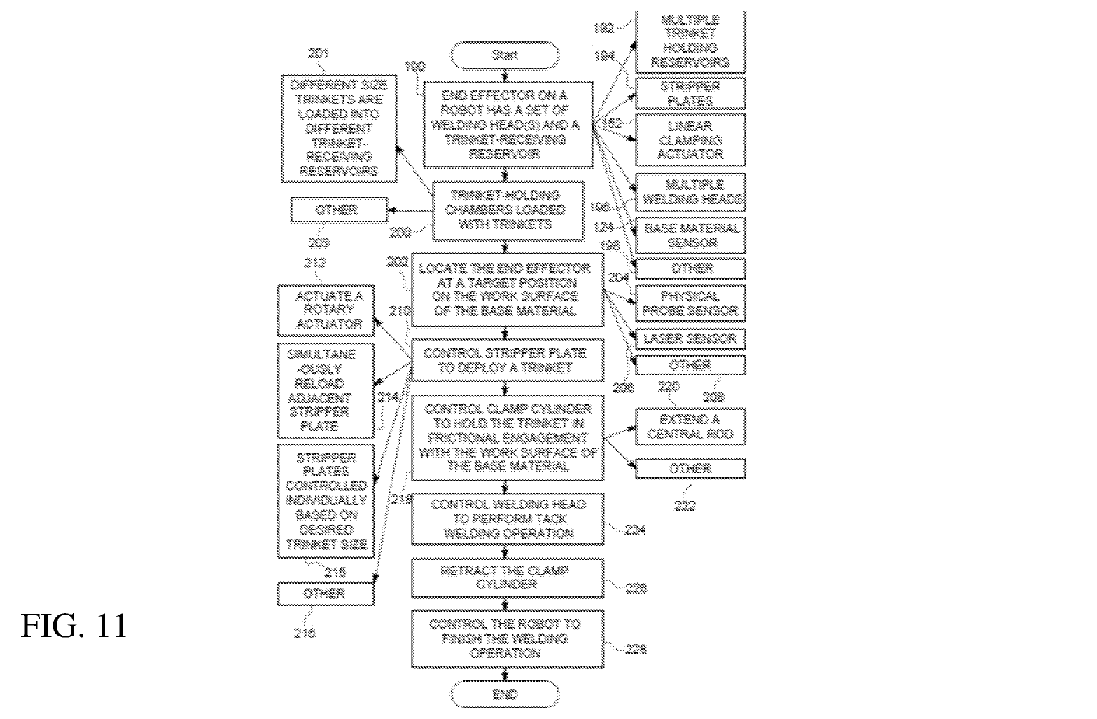

FIG. 11 is a flow diagram showing one example of the operation of end effector 104 in welding a trinket to a work surface. It is first assumed that the end effector 104 is attached to a robotic arm 105 and has a set of welding heads 116 with welding tips 118 and at least one trinket-receiving reservoir 108. Such an end effector is indicated by block 190 in the flow diagram of FIG. 11. In one example, there may be multiple trinket-receiving reservoirs 108, as indicated by block 192. End effector 104 may also have a set of rotary stripper plates 194 that are actuated by rotary actuators. Further, the end effector 104 may have a linear clamping actuator 152 that can be actuated to hold a trinket 111 in frictional engagement with a work surface. Further, there may be multiple welding heads 116 with welding tips 118, as indicated by block 196 and a base material sensor 124 that senses when end effector 104 is in a desired position relative to the work surface or base material. The end effector 104 may be configured in other ways 198 as well.

The trinket-receiving chambers or reservoirs 108 are then loaded with trinkets, as indicated by block 200 in the flow diagram of FIG. 11. In one example, different size trinkets can be loaded into different reservoirs 108, as indicated by block 201. The trinkets can be loaded in other ways as well, as indicated by block 203. Sensor 124 then locates the distal tip 110 of end effector 104 relative to the work surface so the robotic arm can be controlled to move distal tip 110 to a target position relative to the work surface of the base material as indicated by block 202 in the flow diagram of FIG. 11. In one example, the base material sensor 124 is a physical probe sensor, as indicated by block 204. In another example, the sensor 124 is a laser sensor 206 or another type of non-contact sensor. The end effector 104 can be located at a target position relative to the work surface of the base material in other ways as well, as indicated by block 208.

One of the stripper plates 136, 146 is then controlled to deploy a trinket to the deployed position (e.g., the position of trinket 111) as indicated by block 210 in the flow diagram of FIG. 11. The stripper plates can be actuated by a rotary actuator, as indicated by block 212 to move the trinket from the loaded position to the deployed position. Because, in one example, the stripper plates have a plurality of trinket-receiving concavities, actuation of a stripper plate can simultaneously move a trinket with one trinket-receiving concavity to the deployed position and also reload a second trinket-receiving concavity on the stripper plate with a trinket, from a different trinket-receiving reservoir 108, as indicated by block 214 in the flow diagram of FIG. 11. Multiple stripper plates 136146 can be controlled independently. For example, when different chambers are loaded with trinkets of different sizes, then depending on which trinket is needed, a stripper plate can be controlled to load a trinket of the desired size into the deployed position for welding as indicated by block 215. The stripper plates 136, 146 can also be controlled in conjunction with one another to deploy trinkets of varying size and in other ways as well, as indicated by block 216.

Once a trinket 111 is moved into the deployed position, the linear actuator 152 is controlled to hold the trinket 111 in frictional engagement with the work surface of the base material, as indicated by block 218 in the flow diagram of FIG. 11. In one example, the linear actuator is controlled to extend a central rod 154 to engage trinket 111 and hold trinket 111 in frictional engagement with the work surface, as indicated by block 220. The linear actuator can be actuated or controlled in other ways as well, as indicated by block 222.

The welding heads 116 and welding tips 118 are then controlled to perform a tack welding operation to tack weld trinket 111 to the work surface, as indicated by block 224. Once the tack weld is performed, the linear actuator 152 can be retracted to come out of engagement with trinket 111, as indicated by block 226. The robot can then be controlled to control the end effector 104 to finish the welding operation. In one example, welding tips 118 are mounted to end effector 104 by a carriage which can be rotated about an elongate axis 144 of end effector 104 (and thus about trinket 111) to weld the periphery of trinket 111 to the work surface. In another example, the entire end effector 104 can be rotated to move the welding tips 118 about the periphery of trinket 111, to weld trinket 111 to the work surface. The robot 105 can be controlled to finish the welding operation in other ways as well. Finishing the welding operation is indicated by block 228 in the flow diagram of FIG. 11.

It can thus be seen that the present description describes an end effector that holds trinkets in a plurality of chambers on either side of the end effector and those trinkets can be moved to a deployed position by a set of stripper plates. A central actuator or clamp cylinder holds the trinket in place against a base structure while weld heads on either side of the trinket perform a tack weld. The weld heads then perform the remainder of the welding operation to weld the trinket to the base structure. The stripper plates can be alternately actuated to grab and move trinkets from the chambers to the deployed position. One stripper plate may be actuated while the other one is simultaneously loaded with a new trinket. Further, the stripper plates by be multi-position stripper plates so that one part of a stripper plate can be moving a trinket to the deployed position while another part is being reloaded.

What is claimed is:

1. An end effector, comprising:
an attachment surface configured for attachment to a robot;
a first component-receiving reservoir configured to receive a plurality of components and defining a first reservoir chamber that extends from an inlet end of the first component-receiving reservoir to an outlet end of the first component-receiving reservoir;
a second component-receiving reservoir configured to receive a plurality of components and defining a second reservoir chamber that extends from an inlet end of the second component-receiving reservoir to an outlet end of the second component-receiving reservoir;
a distal tip assembly configured to position a component in a deployed position at a distal tip of the end effector; and
a first actuator disposed at the outlet end of the first and second component-receiving reservoirs and configured to alternately move a first component from the first component receiving reservoir to the distal tip assembly and to move a second component from the second component-receiving reservoir to the distal tip assembly.

2. The end effector of claim 1 and further comprising:
an actuator clamp that is actuatable to engage a deployed component positioned in the deployed position at the distal tip of the end effector.

3. The end effector of claim 2 wherein the actuator clamp comprises:
a linear actuator configured to extend to engage the deployed component and hold the deployed component in frictional engagement with a work surface to which the deployed component is to be affixed.

4. The end effector of claim 3 and further comprising:
a first welding head mounted proximate the distal tip at a first position about an elongate axis of the end effector and configured to weld the deployed component to the work surface.

5. The end effector of claim 4 and further comprising:
a second welding head mounted proximate the distal tip and at a second position, spaced from the first position, about the elongate axis of the end effector, and configured to weld the deployed component to the work surface.

6. The end effector of claim 5 wherein the first and second welding heads are mounted for rotation with the end effector about the elongate axis of the end effector and relative to the linear actuator when the linear actuator is holding the deployed component in frictional engagement with the work surface to which the deployed component is to be affixed.

7. The end effector of claim 1 wherein the first actuator comprises:
a first stripper plate having a surface defining a first component-receiving concavity and a second component-receiving concavity.

8. The end effector of claim 7 wherein the first actuator comprises:
a first rotary actuator that is actuatable to move the first stripper plate between a first position which aligns the first component-receiving concavity with the distal tip assembly and which aligns the second component-receiving concavity with the outlet end of the second component-receiving reservoir and a second position which aligns the second component-receiving concavity with the distal tip assembly and which aligns the first component-receiving concavity with the outlet end of the first component-receiving reservoir.

9. The end effector of claim 8 and further comprising:
a third component-receiving reservoir configured to receive a plurality of components and defining a third reservoir chamber that extends from an inlet end of the third component-receiving reservoir to an outlet end of the third component-receiving reservoir; and
a fourth component-receiving reservoir configured to receive a plurality of components and defining a fourth reservoir chamber that extends from an inlet end of the fourth component-receiving reservoir to an outlet end of the fourth component-receiving reservoir.

10. The end effector of claim 9 and further comprising:
a second actuator disposed at the outlet end of the third and fourth component-receiving reservoirs and configured to alternately move a third component from the third component receiving reservoir to the distal tip assembly and to move a fourth component from the fourth component-receiving reservoir to the distal tip assembly.

11. The end effector of claim 10 wherein the second actuator comprises:
a second stripper plate having a surface defining a third component-receiving concavity and a fourth component receiving concavity.

12. The end effector of claim 11 wherein the second actuator comprises:
a second rotary actuator that is actuatable to move the second stripper plate between a first position which aligns the third component-receiving concavity with the distal tip assembly and which aligns the fourth component-receiving concavity with the outlet end of the fourth component-receiving reservoir and a second position which aligns the second component-receiving concavity with the distal tip assembly and which aligns the third component-receiving concavity with the outlet end of the third component-receiving reservoir.

13. The end effector of claim 1 and further comprising:
a surface sensor configured to sense a work surface to which a deployed component in the deployed position is to be affixed.

14. An end effector, comprising:
a first component-receiving reservoir configured to receive a plurality of components and defining a first reservoir chamber that extends from an inlet end of the first component-receiving reservoir to an outlet end of the first component-receiving reservoir;
a distal tip assembly configured to position a component in a deployed position at a distal tip of the end effector;
a first actuator disposed at the outlet end of the first component-receiving reservoir and configured to move a first component from the first component receiving reservoir to the distal tip assembly; and
an actuator clamp that is actuatable to engage a deployed component positioned in the deployed position at the distal tip of the end effector.

15. The end effector of claim 14 wherein the actuator clamp comprises:
a linear actuator configured to extend to engage the deployed component and hold the deployed component in frictional engagement with a work surface to which the deployed component is to be affixed.

16. The end effector of claim 15 and further comprising:
a first welding head mounted for rotation with the end effector about an elongate axis of the end effector and relative to the linear actuator when the linear actuator is holding the deployed component in frictional engagement with the work surface to which the deployed component is to be affixed and
configured to weld the deployed component to the work surface.

17. The end effector of claim 15 and further comprising:
a second component-receiving reservoir configured to receive a plurality of components and defining a second reservoir chamber that extends from an inlet end of the second component-receiving reservoir to an outlet end of the second component-receiving reservoir;
a first stripper plate having a surface defining a first component-receiving concavity and a second component-receiving concavity; and
a first rotary actuator that is actuatable to move the first stripper plate between a first position which aligns the first component-receiving concavity with the distal tip assembly and which aligns the second component-receiving concavity with the outlet end of the second component-receiving reservoir and a second position which aligns the second component-receiving concavity with the distal tip assembly and which aligns the first component-receiving concavity with the outlet end of the first component-receiving reservoir.

18. The end effector of claim 17 and further comprising:
a third component-receiving reservoir configured to receive a plurality of components and defining a third reservoir chamber that extends from an inlet end of the third component-receiving reservoir to an outlet end of the third component-receiving reservoir;
a fourth component-receiving reservoir configured to receive a plurality of components and defining a fourth reservoir chamber that extends from an inlet end of the fourth component-receiving reservoir to an outlet end of the fourth component-receiving reservoir;
a second stripper plate having a surface defining a third component-receiving concavity and a fourth component-receiving concavity; and
a second rotary actuator that is actuatable to move the second stripper plate between a first position which aligns the third component-receiving concavity with the distal tip assembly and which aligns the fourth component-receiving concavity with the outlet end of the fourth component-receiving reservoir and a second position which aligns the second component-receiving concavity with the distal tip assembly and which aligns the third component-receiving concavity with the outlet end of the third component-receiving reservoir.

19. A method of controlling an end effector, comprising:
actuating a first actuator at an outlet end of a first component-receiving reservoir to move a first component from the first component-receiving reservoir to a deployed position at a distal tip assembly of the end effector;
actuating a linear actuator to engage the first component and hold the first component in frictional engagement with a work surface;
actuating a first welding head mounted proximate a first side of the distal tip of the end effector to tack weld the first component to the work surface;
actuating the linear actuator to disengage from the first component; and
rotating the end effector to rotate the first welding head around a portion of the first component to weld the first component to the work surface.

20. The method of claim 19 wherein the first actuator comprises a first stripper plate having a surface defining a first component-receiving concavity and a second component-receiving concavity, and a first rotary actuator and wherein actuating the first actuator comprises:
actuating the first rotary actuator to move the first stripper plate between a first position which aligns the first component-receiving concavity with the distal tip assembly and which aligns the second component-receiving concavity with an outlet end of a second component-receiving reservoir and a second position which aligns the second component-receiving concavity with the distal tip assembly and which aligns the first component-receiving concavity with the outlet end of the first component-receiving reservoir.
